(19) United States
(12) Patent Application Publication
(10) Pub. No.: US 2021/0061199 A1
(43) Pub. Date: Mar. 4, 2021

(54) RETRIEVING AND SETTING SAVED WORK MACHINE OPERATOR PARAMETERS

(71) Applicant: Caterpillar Inc., Peoria, IL (US)

(72) Inventors: Christopher L. Wynkoop, Eureka, IL (US); Steven A. Bettenhausen, Dunlap, IL (US); Keven K. Lockwood, Morton, IL (US); Derek J. Light, Washington, IL (US); Robert E. Shockency, JR., Creve Coeur, IL (US); Adam P. Roesner, Dunlap, IL (US)

(73) Assignee: Caterpillar Inc., Peoria, IL (US)

(21) Appl. No.: 16/555,133

(22) Filed: Aug. 29, 2019

(51) Int. Cl. B60R 16/037; H04L 29/08; B60W 50/08; B60K 35/00

(52) U.S. Cl. CPC B60R 16/037; H04L 67/306; B60W 2050/0064; B60K 35/00; B60W 50/085

(57) ABSTRACT

A machine includes an engine, an electronic display device, and a controller configured to: receive one or more signals indicating an identification of a machine operator; retrieve a name of the operator associated with the identification of the operator in a first data set of machine operators; retrieve one or more saved machine parameters associated with the name of the operator in a second data set of machine parameters; and set one or more current machine parameters to the one or more saved machine parameters.

### TECHNICAL FIELD

The present disclosure relates to systems and methods for improving the efficiency of operating various types of work machines.

### BACKGROUND

There are commonly demands on agricultural, industrial, construction and other heavy machinery applications to increase productivity and efficiency. Additionally, the work machines used in such applications have increased in complexity over time, including requiring a wide variety of machine operating parameters to be set prior to an operator commencing work on a machine. Setting such parameters every time an operator uses a particular machine can be time consuming and repetitive, and, therefore, highly inefficient.

U.S. Pat. No. 8,751,065, filed Dec. 14, 2012, is directed to a vehicle control system that contains a control module configured to wirelessly communicate with a mobile device to upload and download user specific settings that may be stored on the mobile device. The mobile device may also be configured to enable the ignition system once the vehicle authenticates the mobile device and remote keyless entry system. The memory of the mobile device is read and write capable, allowing for data to be used by the control module in conjunction with several automobile systems, and allowing for data to be transferred from said systems to the portable memory device by the control module, thus facilitating vehicle operation. There may be challenges not met by or additional features that may compliment such prior systems.

### SUMMARY

In an example according to this disclosure, a machine includes an engine, an electronic display device, and a controller configured to: receive one or more signals indicating an identification of a machine operator; retrieve a name of the operator associated with the identification of the operator in a first data set of machine operators; retrieve one or more saved machine parameters associated with the name of the operator in a second data set of machine parameters; and set one or more current machine parameters to the one or more saved machine parameters.

In an example, a method of automatically setting operator-specific machine parameters includes receiving, by a controller of a work machine, one or more signals indicating an identification of a machine operator, retrieving, by the controller, a name of the operator associated with the identification of the operator in a first data set of machine operators, retrieving, by the controller, one or more saved machine parameters associated with the name of the operator in a second data set of machine parameters, and setting, by the controller, one or more current machine parameters to the one or more saved machine parameters.

In an example, a machine includes means for providing a motive force to the machine, means for inputting and outputting electronic information, and means for controlling operational characteristics of the machine. The means for controlling is configured to receive one or more signals indicating an identification of a machine operator, retrieve a name of the operator associated with the identification of the operator in a first data set of machine operators, retrieve one or more saved machine parameters associated with the name of the operator in a second data set of machine parameters, and set one or more current machine parameters to the one or more saved machine parameters.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is an elevation view depicting an example machine in accordance with this disclosure.

FIG. 2 is a block diagram depicting the example machine of FIG. 1 and components thereof.

FIG. 3 is a flowchart depicting an example method of automatically setting operator-specific machine parameters.

### DETAILED DESCRIPTION

Examples according to this disclosure are directed to methods and systems for automatically retrieving saved work machine parameters for a particular operator of the machine and automatically setting the work machine to operate in accordance with the saved parameters.

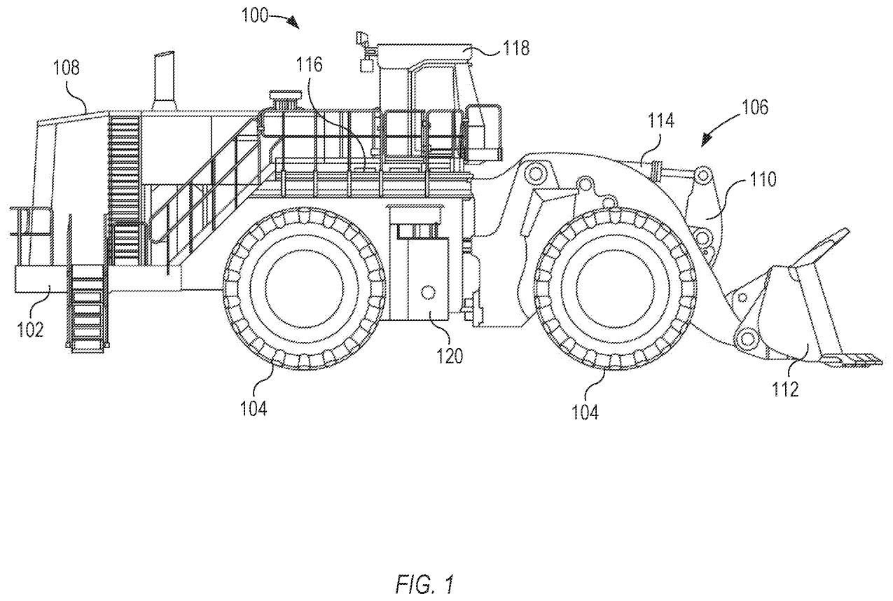

FIG. 1 depicts an example machine 100 in accordance with this disclosure. In FIG. 1, machine 100 includes frame 102, wheels 104, and implement 106. Example machine 100 is a wheel loader. In other examples, however, the machine may be other types of machines related to various industries, including, as examples, construction, agriculture, forestry, transportation, material handling, waste management, and so on. Accordingly, although a number of examples are described with reference to a wheel loader machine, examples according to this disclosure are also applicable to other types of machines including graders, scrapers, dozers, excavators, compactors, material haulers like dump trucks, along with other example machine types.

Machine 100 includes frame 102 mounted on four wheels 104, although, in other examples, the machine could have more than four wheels. Frame 102 is configured to support and/or mount one or more components of machine 100. For example, machine 100 includes enclosure 108 coupled to frame 102. Enclosure 108 can house, among other components, an engine and/or other drive system to propel the machine over various terrain via wheels 106. The engine can include various power generation platforms, including, for example, an internal combustion engine, whether gasoline or diesel.

Machine 100 includes implement 106 coupled to the frame 102 through linkage assembly 110, which is configured to be actuated to articulate bucket 112 of implement 106. Bucket 112 of implement 106 may be configured to transfer material such as, soil or debris, from one location to another. Linkage assembly 110 can include one or more cylinders 114 configured to be actuated hydraulically or pneumatically, for example, to articulate bucket 112. For example, linkage assembly 110 can be actuated by cylinders 114 to raise and lower and/or rotate bucket 112 relative to frame 102 of machine 100.

Platform 116 is coupled to frame 102 and provides access to various locations on machine 100 for operational and/or maintenance purposes. Machine 100 also includes an operator cabin 118, which can be open or enclosed and may be accessed via platform 114. Operator cabin 118 may include one or more control devices (not shown) such as, a joystick, a steering wheel, pedals, levers, buttons, switches, among other examples. The control devices are configured to enable the operator to control machine 100 and/or the implement 106. Operator cabin 118 may also include an operator interface such as, a display device, a sound source, a light source, or a combination thereof.

In an example, operator cabin 118 includes an input/output device to review and enter various parameters controlling operation of machine 100. For example, operator cabin 118 can include a touch-screen input and display device, by which an operator of machine 100 can review machine operating parameters and also enter desired values for such parameters. Machine 100 can also include a controller. The controller of machine 100 can include or be incorporated into various systems of machine 100. For example, the controller of machine 100 may be an electronic control unit (ECU) of machine 100. As another example, the controller of machine 100 may be included in/incorporated into a touch-screen device in operator cabin 118. In any event, the controller of machine 100 can be configured to execute one or more programs related to operation of machine 100. For example, the controller of machine 100 can be configured to automatically retrieve saved work machine parameters for a particular operator of machine 100 and automatically set the work machine to operate in accordance with the saved parameters.

Machine 100 can include a tank compartment connected to frame 102 and including fuel tank 120. Fuel tank 120 is fluidly coupled to the engine. Tank 120 is configured to store a fuel therein and serve as a source for supply of the fuel to the engine of machine 100. Machine 100 may also include other tanks, for example, to store and supply hydraulic fluid to implement 106 or other components of machine 100.

Machine 100 can be used in a variety of industrial, construction, commercial or other applications. Machine 100 can be operated by an operator in operator cabin 118. The operator can, for example, drive machine 100 to and from various locations on a work site and can also pick up and deposit loads of material using bucket 112 of implement 106. As an example, machine 100 can be used to excavate a portion of a work site by actuating cylinders 114 to articulate bucket 112 via linkage 110 to dig into and remove dirt, rock, sand, etc. from a portion of the work site and deposit this load in another location.

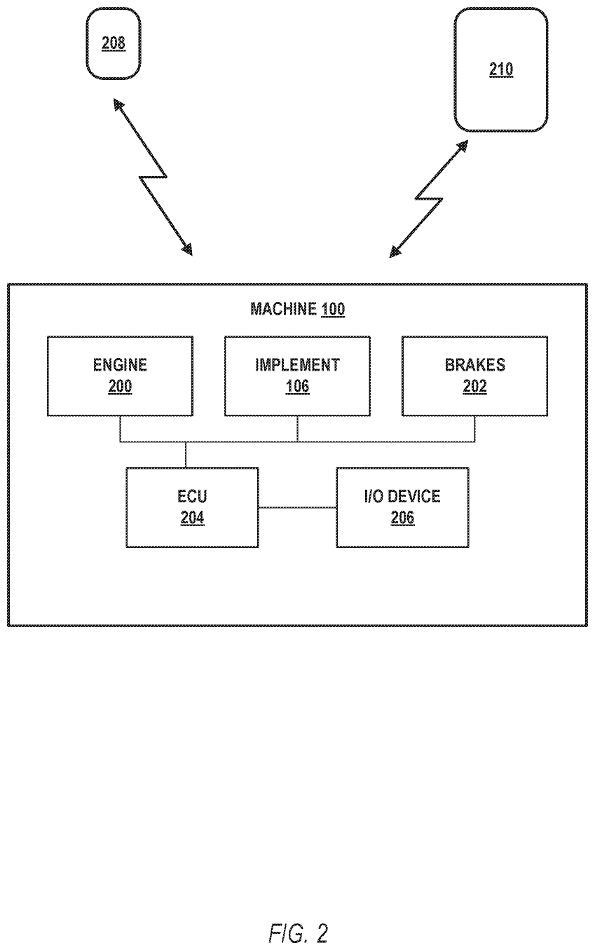

FIG. 2 is a block diagram depicting machine 100 and a number of sub-systems thereof, including engine 200, implement 106, service brakes 202, electronic control unit (ECU) 204, and input/output (I/O) device 206. ECU 204 is configured to automatically retrieve saved work machine parameters for a particular operator of machine 100 and automatically set the work machine to operate in accordance with the saved parameters.

ECU 204 is, as depicted schematically in FIG. 2, communicatively connected to engine 200, implement 106, brakes 202, and I/O device 206. ECU 204 can include software, hardware, and combinations of hardware and software configured to execute a number of functions related to automatically e.g., without operator input) retrieving saved machine parameters and setting work machine 100 to operate in accordance with the saved parameters. ECU 204 can be an analog, digital, or combination analog and digital controller including a number of components. As examples, ECU 204 can include integrated circuit boards or ICB(s), printed circuit boards PCB(s), processor(s), data storage devices, switches, relays, etcetera. Examples of processors can include any one or more of a microprocessor, a controller, a digital signal processor (DSP), an application specific integrated circuit (ASIC), a field-programmable gate array (FPGA), or equivalent discrete or integrated logic circuitry.

ECU 204 may include storage media to store and/or retrieve data or other information, for example, signals from sensors. Storage devices, in some examples, are described as a computer-readable storage medium. In some examples, storage devices include a temporary memory, meaning that a principal purpose of one or more storage devices is not long-term storage. Storage devices are, in some examples, described as a volatile memory, meaning that storage devices do not maintain stored contents when the computer is turned off. Examples of volatile memories include random access memories (RAM), dynamic random access memories (DRAM), static random access memories (SRAM), and other forms of volatile memories known in the art. The data storage devices can be used to store program instructions for execution by processor(s) of ECU 204. The storage devices, for example, are used by software, applications, algorithms, as examples, running on and/or executed by ECU 204. The storage devices can include short-term and/or long-term memory, and can be volatile and/or non-volatile. Examples of non-volatile storage elements include magnetic hard discs, optical discs, floppy discs, flash memories, or forms of electrically programmable memories (EPROM) or electrically erasable and programmable (EEPROM) memories.

ECU 204 can be configured to communicate with engine 200, implement 106, brakes 202, and I/O device 206 via various wired or wireless communications technologies and components using various public and/or proprietary standards and/or protocols. In some examples, ECU 204 and other components of machine 100 will communicate over a local wired communication and/or power network of machine 100. However, ECU 204 can also be configured to communicate wirelessly. Additionally, ECU 204 can be configured to use various transport mediums and protocols for communicating with components of machine 100, including, for example, Ethernet, Transmission Control Protocol/Internet Protocol (TCP/IP), 802.11 or Bluetooth, or other standard or proprietary communication protocols. Additionally, ECU 204 can be configured to communicate using a Controller Area Network (CAN) protocol.

In an example, ECU 204 is configured to automatically retrieve saved work machine parameters for a particular operator of machine 100 and automatically set the work machine to operate in accordance with the saved parameters. In order to operate work machine 100, an operator of the machine may be required to set a variety of machine operating parameters prior to commencing work. Setting such parameters every time a particular operator uses a particular machine can be time consuming and repetitive, and, therefore, highly inefficient.

In some cases, when an operator sets up machine 100, the operator may electronically login to various control systems of machine 100, including, for example, logging into ECU 204 and/or I/O device 206. Operator login is commonly enabled through multiple possible login mechanisms. For example, the operator can login to machine 100 by entering security credentials into I/O device 206. Additionally or alternatively, the operator can use an operator device to automatically or with operator interaction communicate a security credential to ECU 204 of machine 100. For example, the operator may have wireless fob device 208, like a Bluetooth fob, which is configured to automatically communicate with ECU 204 based on the proximity of portable fob device 208 to machine 100 and ECU 204. In such a case, the operator may be automatically logged into machine 100/ECU 204 upon entering operator cabin 118 with wireless fob device 208. In another example, the operator may log into machine 100 using cellular phone 210. For example, the operator may use an application executed on cellular phone 210 to control phone 210 to communicate a security credential to machine 100/ECU 204.

Each of these multiple login mechanisms may identify the particular operator via different unique keys or unique identifications (IDs). As such, in order to identify the particular operator across multiple login mechanisms in order to retrieve and load a set of saved machine operating parameters associated with the operator may require associating a universal identification of the operator with each of the unique keys or unique IDs for the respective different login mechanisms.

In an example, ECU 204 is configured to receive one or more signals indicating an identification of a machine operator, retrieve a name of the operator associated with the identification of the operator in a first data set of machine operators, retrieve one or more saved machine parameters associated with the name of the operator in a second data set of machine parameters, and set one or more current machine parameters to the one or more saved machine parameters. For example, ECU 204 is configured to receive one or more signals from I/O device 206, wireless fob 208, or cellular phone 210, which signal(s) indicate an identification for the current operator of machine 100. The identification of the current operator can be, for example, a security key associated with the operator and stored in one or more data sets (for example, tables, databases, or other collection of data) on ECU 204 and/or I/O device 206 of machine 100.

ECU 204 can then retrieve a name of the operator associated with the identification of the operator in a first data set of machine operators stored in ECU 204 and/or I/O device 206. For example, ECU 204 and/or I/O device 206 can store a table, database or other collection of data, which associates multiple operator identifications with a single operator name. ECU 204 can receive the identification of the operator and look-up this identification in the first data set and retrieve the name of the operator associated with the received identification.

In some cases, ECU 204 can also authenticate the operator using the security credentials. For example, if the operator enters security credentials via I/O device 206, e.g. enters a username and password, ECU 204 can authenticate these credentials by referencing a stored table, list, database, etcetera of authorized users of machine 100. In another example, operator uses an application running on cellular phone 210 to wirelessly communicate an encrypted credential to ECU 204. ECU 204 can then use a stored key to decrypt the credential and authenticate the operator to operate machine 100.

After determining and retrieving the name of the operator (and, in some cases, authenticating the operator to use machine 100), ECU 204 can retrieve one or more saved machine parameters associated with the name of the operator in a second data set of machine parameters. For example, ECU 204 and/or I/O device 206 can store a table, database or other collection of data, which associates each of a plurality of operator names with a set of one or more saved machine parameters. ECU 204 can retrieve the name of the operator and look-up this operator name in the second data set and retrieve the saved machine parameters associated with the name of the operator.

After retrieving the saved machine parameters associated with the name of the operator, ECU 204 can set one or more current parameters of machine 100 to the one or more saved machine parameters. For example, ECU 204 can communicate with engine 200, implement 106, brakes 202, and various other components of machine 100 to set operational parameters of these components to the saved machine parameters associated with the particular operator currently operating machine 100.

The saved machine parameters for operators can include a number of different parameters related to different parts/components of machine 100. For example, some machine parameters may relate to I/O device 206. As another example, some of machine parameters may relate to various operating characteristics of implement 106. As an additional example, the saved machine parameters may relate to a transmission of machine 100.

The foregoing process executed by ECU 204 can be implemented with various levels of automation. In one example, ECU 204 is configured to automatically set the current operating parameters of machine 100 to the saved parameters for the operator without any interaction or confirmation from the operator. For example, the operator may enter cabin 118 of machine 100. ECU 204 and/or I/O device 206 may automatically communicate with wireless fob 208 and retrieve an identification of the operator from fob 208. ECU 204 may then retrieve the name of the operator associated with the identification of the operator from a first data set stored in ECU 204 and/or I/O device 206 and retrieve the saved operating parameters associated with the operator name from a second data set stored in ECU 204 and/or I/O device 206, again without any interaction or confirmation from the operator. Additionally, ECU 204 may automatically set the current operating parameters of machine 100 to the saved machine parameters of the operator. Thus, the operator may enter cabin 118 and shortly thereafter have their particular saved machine parameters automatically set on machine 100.

In another example, the operator may enter cabin 118 of machine 100 and enter security credential(s) on I/O device 206. I/O device 206 may communicate the security credential (e.g., signals indicative of such entered credential(s)) including an identification of the operator to ECU 204. ECU 204 may then retrieve the name of the operator associated with the identification of the operator from a first data set stored in ECU 204 and/or I/O device 206 and retrieve the saved operating parameters associated with the operator name from a second data set stored in ECU 204 and/or I/O device 206, again without any interaction or confirmation from the operator. Before setting the current parameters of machine 100 to the saved parameters, however. ECU 204 may communicate command or other signals to I/O device 206 to cause I/O device 206 to generate an output requesting confirmation that the current machine parameters should be set to the saved machine parameters for the operator. In this case, the operator can enter a confirmation via I/O device 206, in which case I/O device 206 can communicate the confirmation to ECU 204 and ECU 204 can proceed to set the current operating parameters of machine 100 to the saved machine parameters of the operator. Additionally, the operator may use I/O device 206 to decline setting the saved parameters at that time.

In some cases, changing/setting the current parameters of machine 100 to the saved parameters of the current operator of the machine may be based on additional conditions. In an example, ECU 204 is configured to, prior to setting the current parameters of machine 100 to the saved parameters of the operator, determine a current operating state of the machine. For example, ECU 204 may be configured to determine if machine 100 is in an idle state and, only set the current parameters to the operator's saved parameters if machine 100 is in the idle state. In an example, if ECU 204 determines that machine 100 is not in an idle state, ECU 204 is configured to postpone setting the current machine parameters to the saved machine parameters. For example, ECU 204 can postpone setting the current machine parameters to the saved machine parameters until the next time machine 100 enters an idle state.

ECU 204 can execute this determination in a variety of ways. For example, ECU 204 can communicate with an ECU of engine 200, sometimes referred to as an engine control module (ECM), or can communicate with an ECU of a transmission of machine 100, sometimes referred to as a transmission control module (TCM). The ECM or TCM, as examples, of machine 100 can return the current operating state of machine 100 to ECU 204, and ECU 204 can respond appropriately based on the returned current state of the machine.

While the operator of machine 100 may benefit from the efficiency of ECU 204 automatically determining and setting the operator's saved machine parameters, there may also be instances in which the operator wishes to adjust or otherwise change one or more of the saved parameters. In such cases, as an example, ECU 204 can be configured to receive one or more signals indicating changes to the saved machine parameters of the operator in response to input on I/O device 206, and save the changes to the saved machine parameters associated with the operator name in the second data set of machine parameters stored on ECU 204 and/or I/O device 206. Thus, the next time the operator uses work machine 100, ECU 204 will automatically or in conjunction with operator confirmation set the operating parameters of machine 100 to the changed saved parameters of the operator.

ECU 204 can execute the storage of the changed operator parameters without input from the operator. For example, any time that the operator changes a machine parameter via I/O device 206, ECU 204 automatically receives an indication of the change from I/O device 206 and saves the changes in the second data set making the storage of changes transparent to the operator and executed in the background of applications running on I/O device 206.

ECU 204 and associated functions thereof can be implemented on machine 100 in a variety of ways. For example, ECU 204 can be implemented on one or more electronic control units (ECUs) of machine 100. Some common types of ECUs on work machines include Electronic/engine Control Module, Powertrain Control Module, Transmission Control Module, Brake Control Module, Suspension Control Module, among other examples. In the case of industrial, construction, and other heavy machinery, example ECUs can also include an Implement Control Module associated with one or more implements coupled to and operable from the machine. ECU 204 can be implemented on, as an example, an Engine Control Module (ECM) associated with engine 200, an Implement Control Module (ICM) associated with implement 106, or a Transmission Control Module (TCM) associated with a transmission of machine 100.

In some examples, ECU 204 may be included in I/O device 206. For example, I/O device 206 may be the main or sole input and output device by which operators of machine 100 control the operation thereof. I/O device 206 can include not only components for displaying and entering/inputting data or other information, but also various electronic storage media and processors. In some examples, therefore, a portion or certain components of I/O device 206 may be configured to execute the functions described above with reference to ECU 204.

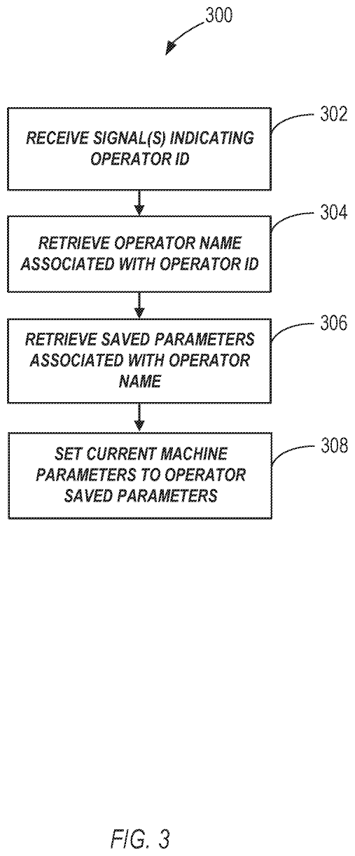

FIG. 3 is a flowchart depicting example method 300 of automatically setting operator-specific machine parameters. Example method 300 includes receiving one or more signals indicating an identification of a machine operator (302), retrieving a name of the operator associated with the identification of the operator in a first data set of machine operators (304), retrieving one or more saved machine parameters associated with the name of the operator in a second data set of machine parameters (306), and setting one or more current machine parameters to the one or more saved machine parameters (308).

In an example, receiving the one or more signals indicating the identification of the operator (302) includes wirelessly receiving the identification of the operator from an operator device. In an example, wirelessly receiving the identification of the operator from the operator device includes automatically wirelessly receiving the identification of the operator based on a proximity of the operator device to the machine. In an example, wirelessly receiving the identification of the operator from the operator device includes wirelessly receiving the identification of the operator in response to an input on the operator device. In an example, receiving the one or more signals indicating the identification of the operator includes receiving the identification of the operator in response to an input on the electronic display device.

In an example, method 300 includes, prior to setting the one or more current machine parameters to the one or more saved machine parameters, causing the electronic display device to generate an output requesting confirmation that the one or more current machine parameters should be set to the one or more saved machine parameters. In an example, method 300 includes, prior to setting the one or more current machine parameters to the one or more saved machine parameters, determining a current operating state of the machine. In an example, determining the current operating state of the machine includes determining if the machine is in an idle state. In an example, method 300 includes postponing setting the one or more current machine parameters to the one or more saved machine parameters if the machine is not in the idle state.

In an example, method 300 includes receiving one or more signals indicating changes to the one or more saved machine parameters in response to input on the electronic display device, and saving the changes to the one or more saved machine parameters associated with the operator name in the second data set of machine parameters.

### INDUSTRIAL APPLICABILITY

In an operating example of a work machine according to this disclosure, an ECU of the work machine is configured to automatically set the current operating parameters of the machine to the saved parameters for the operator without any interaction or confirmation from the operator. For example, the operator enters the operator cabin of the machine. The ECU automatically communicates with a wireless operator device and retrieves an identification of the operator from the operator device. The ECU then retrieves the name of the operator associated with the identification of the operator from a first data set stored in the ECU (or another device/system of the machine) and retrieves the saved operating parameters associated with the operator name from a second data set stored in the ECU, again without any interaction or confirmation from the operator. Additionally, the ECU automatically sets the current operating parameters of the machine to the saved machine parameters of the operator.

In another example, the operator enters the operator cabin of the machine and enters security credential(s) on an I/O device of the machine. The I/o device communicates the security credential (e.g., signals indicative of such entered credential(s)) including an identification of the operator to an ECU of the machine. The ECU retrieves the name of the operator associated with the identification of the operator from a first data set and retrieves the saved operating parameters associated with the operator name from a second data set, again without any interaction or confirmation from the operator.

Before setting the current parameters of the work machine to the saved parameters, however, the ECU communicates command or other signals to the I/O device to cause the I/O device to generate an output requesting confirmation that the current machine parameters should be set to the saved machine parameters for the operator. The operator enters a confirmation via the I/O device, and the I/O device communicates the confirmation to the ECU. The ECU 204 proceeds to set the current operating parameters of the machine to the saved machine parameters of the operator. Additionally, in some cases, the operator may use the I/O device to decline setting the saved parameters at that time.

In some cases, changing/setting the current parameters of the machine to the saved parameters of the current operator of the machine may be based on additional conditions. In an example, an ECU of the machine, prior to setting the current parameters of the machine to the saved parameters of the operator, determines a current operating state of the machine. The ECU, for example, determine if the machine in an idle state and, only set the current parameters to the operator's saved parameters if the machine is in the idle state. If the ECU determines that the machine is not in an idle state, the ECU postpones setting the current machine parameters to the saved machine parameters.

There may be instances in which the operator wishes to adjust or otherwise change one or more of the saved parameters. In such cases, an ECU of the work machine receives one or more signals indicating changes to the saved machine parameters of the operator in response to input on an I/O device of the machine. The ECU saves the changes to the saved machine parameters associated with the operator name in the second data set of machine parameters. Thus, the next time the operator uses the work machine, the ECU will automatically or in conjunction with operator confirmation set the operating parameters of the machine to the changed saved parameters of the operator.

The above detailed description is intended to be illustrative, and not restrictive. The scope of the disclosure should, therefore, be determined with references to the appended claims, along with the full scope of equivalents to which such claims are entitled.

What is claimed is:

1. A machine comprising:
an engine;
an electronic input/output device; and
a controller configured to:
receive one or more signals indicating an identification of a machine operator;
retrieve a name of the operator associated with the identification of the operator in a first data set of machine operators;
retrieve one or more saved machine parameters associated with the name of the operator in a second data set of machine parameters; and
set one or more current machine parameters to the one or more saved machine parameters.

2. The machine of claim 1, wherein the controller configured to receive the one or more signals indicating the identification of the operator comprises the controller configured to wirelessly receive the identification of the operator from an operator device.

3. The machine of claim 2, wherein the controller configured to wirelessly receive the identification of the operator from the operator device comprises the controller configured to automatically wirelessly receive the identification of the operator based on a proximity of the operator device to the machine.

4. The machine of claim 2, wherein the controller configured to wirelessly receive the identification of the operator from the operator device comprises the controller configured to wirelessly receive the identification of the operator in response to an input on the operator device.

5. The machine of claim 1, wherein the controller configured to receive the one or more signals indicating the identification of the operator comprises the controller configured to receive the identification of the operator in response to an input on the electronic input/output device.

6. The machine of claim 1, wherein the controller is further configured to, prior to setting the one or more current machine parameters to the one or more saved machine parameters, cause the electronic input/output device to generate an output requesting confirmation that the one or more current machine parameters should be set to the one or more saved machine parameters.

7. The machine of claim 1, wherein the controller is further configured to, prior to setting the one or more current machine parameters to the one or more saved machine parameters, determine a current operating state of the machine.

8. The machine of claim 7, wherein the controller configured to determine the current operating state of the machine comprises the controller configured to determine if the machine is in an idle state.

9. The machine of claim 8, wherein the controller is configured to postpone setting the one or more current machine parameters to the one or more saved machine parameters if the machine is not in the idle state.

10. The machine of claim 1, wherein the controller is further configured to:
receive one or more signals indicating changes to the one or more saved machine parameters in response to input on the electronic display device; and
save the changes to the one or more saved machine parameters associated with the operator name in the second data set of machine parameters.

11. A method of automatically setting operator-specific machine parameters, the method comprising:
receiving, by a controller of a work machine, one or more signals indicating an identification of a machine operator;
retrieving, by the controller, a name of the operator associated with the identification of the operator in a first data set of machine operators;
retrieving, by the controller, one or more saved machine parameters associated with the name of the operator in a second data set of machine parameters; and
setting, by the controller, one or more current machine parameters to the one or more saved machine parameters.

12. The method of claim 11, wherein receiving the one or more signals indicating the identification of the operator comprises wirelessly receiving the identification of the operator from an operator device.

13. The method of claim 12, wherein wirelessly receiving the identification of the operator from the operator device comprises automatically wirelessly receiving the identification of the operator based on a proximity of the operator device to the machine.

14. The method of claim 12, wherein wirelessly receiving the identification of the operator from the operator device comprises wirelessly receiving the identification of the operator in response to an input on the operator device.

15. The method of claim 11, wherein receiving the one or more signals indicating the identification of the operator comprises receiving the identification of the operator in response to an input on the electronic display device.

16. The method of claim 11, further comprising, prior to setting the one or more current machine parameters to the one or more saved machine parameters, causing the electronic display device to generate an output requesting confirmation that the one or more current machine parameters should be set to the one or more saved machine parameters.

17. The method of claim 1, further comprising, prior to setting the one or more current machine parameters to the one or more saved machine parameters, determining a current operating state of the machine.

18. The method of claim 17, wherein determining the current operating state of the machine comprises determining if the machine is in an idle state.

19. The method of claim 18, further comprising postponing setting the one or more current machine parameters to the one or more saved machine parameters if the machine is not in the idle state.

20. The method of claim 1, further comprising:
receiving, by the controller, one or more signals indicating changes to the one or more saved machine parameters in response to input on the electronic display device; and
saving, by the controller, the changes to the one or more saved machine parameters associated with the operator name in the second data set of machine parameters.

21. A machine comprising:
means for providing a motive force to the machine;
means for inputting and outputting electronic information; and
means for controlling operational characteristics of the machine, the means for controlling configured to:
receive one or more signals indicating an identification of a machine operator;
retrieve a name of the operator associated with the identification of the operator in a first data set of machine operators;
retrieve one or more saved machine parameters associated with the name of the operator in a second data set of machine parameters; and
set one or more current machine parameters to the one or more saved machine parameters.
